(19) United States
(12) Patent Application Publication
(10) Pub. No.: US 2025/0338098 A1
(43) Pub. Date: Oct. 30, 2025

(54) METHOD FOR THE USER-RELATED SETUP OF A TERMINAL DEVICE

(71) Applicant: GIESECKE+DEVRIENT MOBILE SECURITY GERMANY GMBH, Munchen (DE)

(72) Inventor: Michael HESS, Putzbrunn (DE)

(21) Appl. No.: 18/867,169

(22) PCT Filed: May 24, 2023
(86) PCT No.: PCT/DE2023/100391

§ 371 Date: Nov. 19, 2024

(30) Foreign Application Priority Data
May 25, 2022 (DE) 10 2022 001 848.9

(51) Int. Cl. H04W 4/50; H04W 8/20; H04W 12/06; H04W 12/084; H04W 12/30; H04W 12/43

(52) U.S. Cl. CPC H04W 4/50; H04W 8/205; H04W 12/06; H04W 12/084; H04W 12/35; H04W 12/43

(57) ABSTRACT

A method is for the user-related setup of a terminal device connected to a background system. The terminal device is connected to a data exchange network by means of a telecommunications profile stored in a secure element. A service platform is connected to the background system and to at least one network operator operating a data exchange network. An authorization token for providing a telecommunications profile belonging to the authorization token is stored in the service platform. The authorization token is linked to a group identifier. The service platform receives a group identifier or a profile request designating a group identifier from a background system and determines an authorization token linked to the group identifier.

The invention relates to a method for user-related setup of a user terminal device which is connected to a background system, and to a service platform for a management system for the user-related setup of a terminal device. In particular, the invention relates to the connection of a vehicle to a mobile radio network and the configuration of services provided by the vehicle.

WO2021/170506 A1 discloses a method for introducing a communication function into a terminal device, according to which a user generates an initialization message, in response to which a request for implementing a communication profile is directed to a management server from the terminal device. Based on the request, the management server exchanges data with a network operator. Finally, the network operator sends an activation message to the terminal device to implement a communication profile. To identify the user in the dialog between management server and network operator, a universal network token is generated by the network operator.

U.S. Pat. No. 10,735,944 B2 discloses an eSIM management system which connects mobile radio network operators, terminal devices of different subscribers and different eSIM providers to one another. The management system allows an immediate, request-driven provision of an optimal profile for a terminal device based on individual terminal device attributes that describe technical and functional properties of the terminal device. The terminal device sends a profile request and attributes to the management system, which selects the best possible profile according to the attributes by accessing a database and then commissions an eSIM provider to create and deliver a corresponding profile. The known solution makes it possible to provide an optimized profile to a newly connected terminal device in the management system without having to take special precautions about who provides the profile.

US 2016/0020802 A1 discloses an eSIM provisioning method that allows a profile to be quickly downloaded to a terminal device. To do this, an image file is transferred from a profile management server and a profile is set up on the basis of this image file.

EP 3065431 describes a method for inserting a profile into an eUICC in which a download certificate and addressing information are submitted to a data preparation unit, by means of which a profile is retrieved from the data preparation unit and transferred to the eUICC. A relevant use case in practice is to use an existing telecommunications profile set up for a first terminal device for another terminal device. The object of the invention is to specify a management system that is particularly suitable for this application case.

The object is achieved by a method having the features of claim 1. The method according to the invention uses a group identifier which advantageously allows a group identifier assigned for a first terminal device to be also used for setting up a second or a plurality of further terminal devices.

For this purpose, a service platform is advantageously provided, which is connected to network operators on the one hand and to the background systems assigned to terminal devices on the other. The service platform stores control data that is linked to a group identifier. After transmission, the control data enables a terminal device to effect the provision of a telecommunications profile via a network operator and also the configuration of services provided by the terminal device.

The solution according to the invention is particularly advantageous for vehicles. Here, a technical development is aimed at using the vehicle windows for additional purposes and to this end, furnishing them with materials that counteract the transmission of mobile communication signals. By setting up the functionality of a mobile communication subscriber in the vehicle and using the on-board equipment to connect to a mobile communication network, a mobile communication connection is available to a user regardless of whether their own cellphone could do this or whether the user has their own cellphone with them at all.

Another advantage of the solution according to the invention is that operators of background systems only need to adapt their system to a service platform once in order to provide the facility for connecting a terminal device assigned to the background system to a wide range of network operators. Similarly, network operators only need to adapt their respective data exchange network to a service platform once in order subsequently to be able to offer access to their data exchange network via a wide range of background systems.

In the following, exemplary embodiments of the invention are explained in more detail based on the drawing, in which:

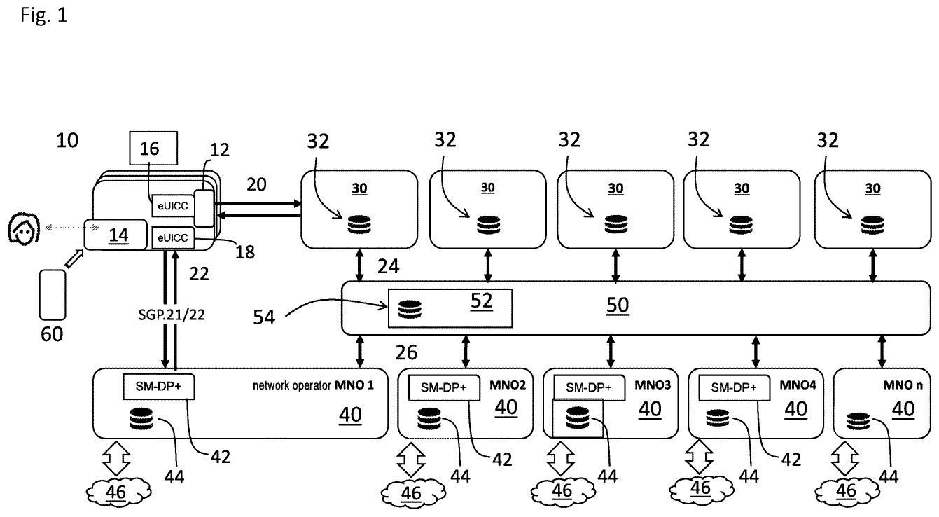

FIG. 1 shows a platform-based management system for managing a plurality of terminal devices;

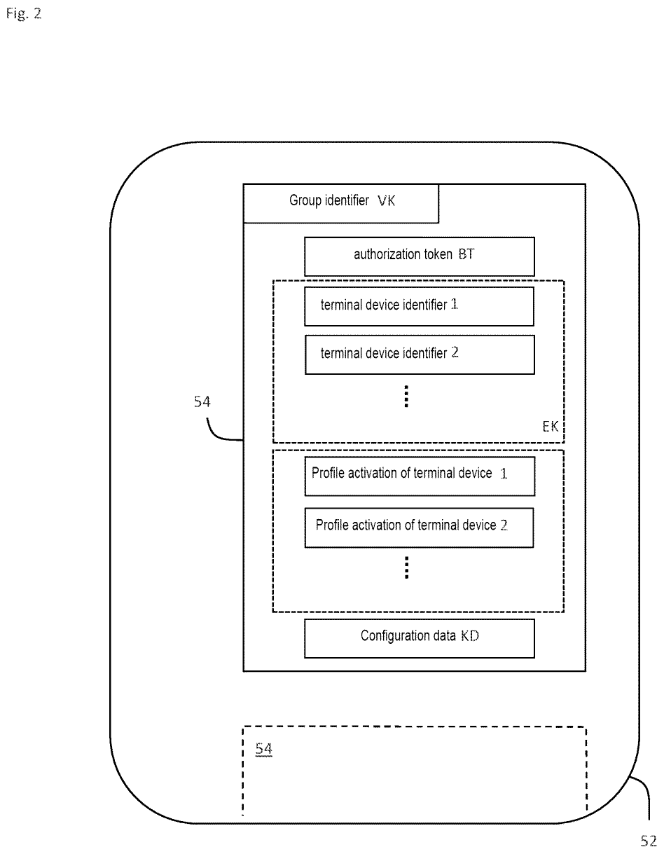

FIG. 2 shows part of a storage device of a service platform;

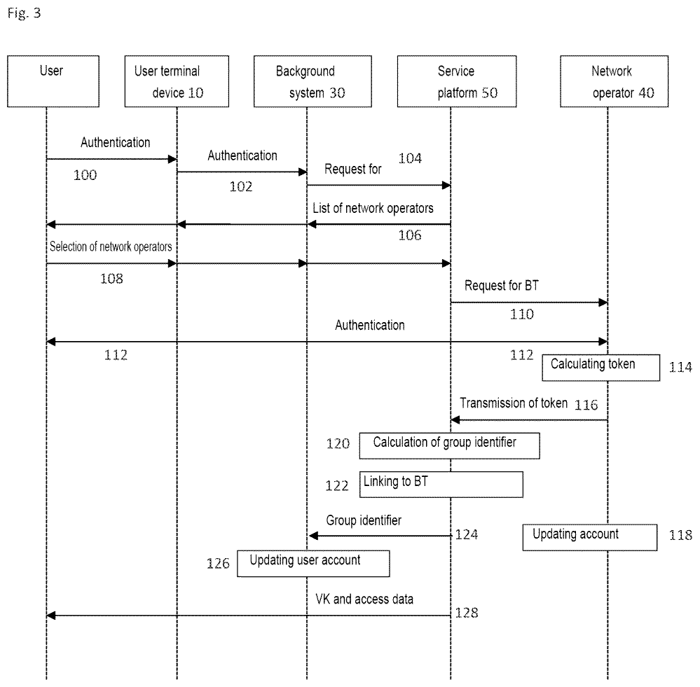

FIG. 3 shows a login routine for setting up a group identifier on a service platform;

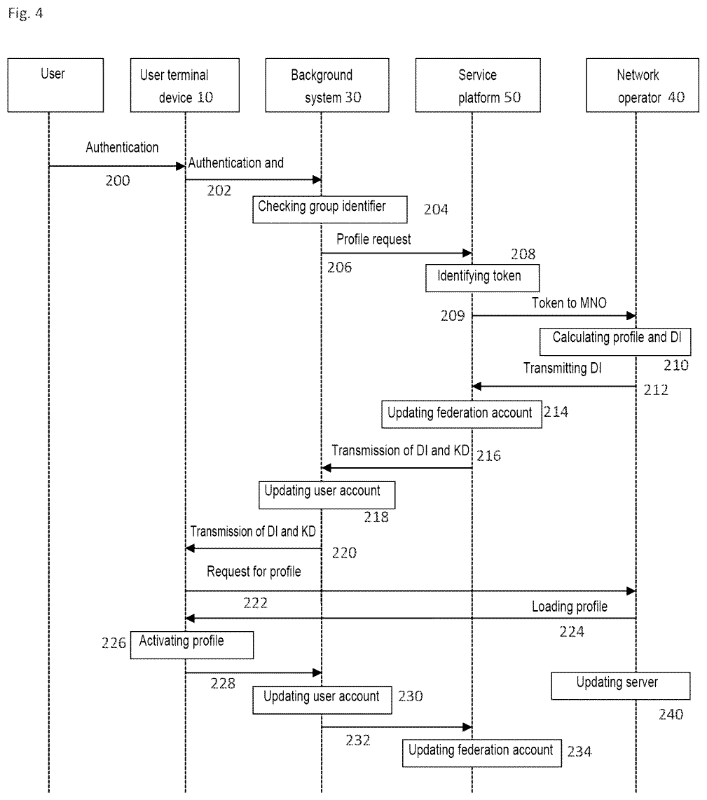

FIG. 4 shows the user-related setup of a terminal device via an assigned background system if a group identifier is already stored in the background system;

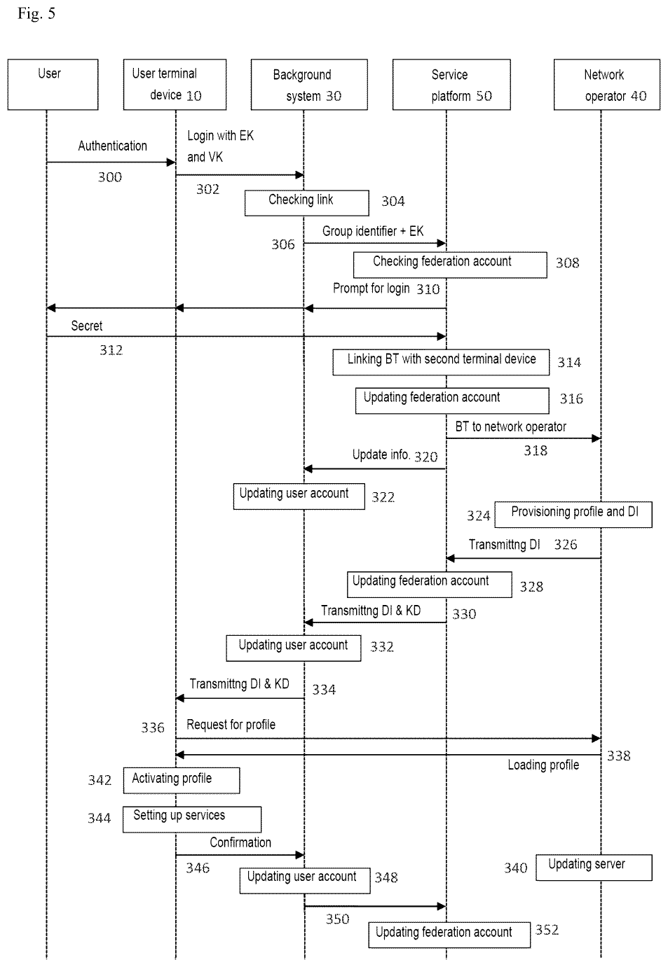

FIG. 5 shows the user-related setup of a second terminal device via an assigned background system, if no group identifier for the user is stored in the background system yet, but a federation account is already set up on the service platform as a user account.

FIG. 1 shows a platform-based management system for managing a plurality of terminal devices 10. Each terminal device 10 is connected to an assigned background system 30 via a data link 20. Each terminal device 10 is also able to connect via a further data link 22 to a data exchange network 46 which is provided by different network operators 40, according to user choice. Each background system 30 and each network operator 40 is connected to a service platform 50 via a further data link 24 and 26 respectively.

The terminal device 10 is a user terminal device and may be, for example, a vehicle connected to a manufacturer management system. The manufacturer management system in this case forms the background system 30. The terminal device 10 has a user interface 12 and can be connected via a first data link 22 to a network operator 40 and is connected via a second data link 20 to the manufacturer management system 30, according to user choice.

The network operators 40 are typically mobile communication providers and the data links 22 are implemented in a mobile communication network 46, which is provided by a network operator 40. Via the data links 22, the network operators 40 provide communications and other digital services in a known manner.

The data links 20 to the manufacturer management system 30 and likewise the data links 24, 26 can also be designed as a mobile communication link in a mobile communication network 46 and be provided by one or more network operators 40. Other types of data links and data or telecommunications networks are also possible however.

All data links 20, 22, 24, 26 are expediently encrypted and secured against unauthorized access.

Each background system 30 is usually assigned to a set of specific terminal devices 10. It provides services tailored to the respective terminal devices 10 via the data link 20. A user account 32 is maintained in the background system 30. Each user account 32 is assigned one or more terminal devices 10. The user account 32 stores an identifier and optionally, individual terminal device data for each user. The identifier can also be assigned to an authentication device 60 of the user.

A background system 30 can be operated, for example, by a vehicle manufacturer or a car rental company and provides additional services for vehicles of this manufacturer or this car rental company.

The service platform 50 coordinates the connection of the terminal devices 10 to respective network operators 40 and brings about the user-related setup of the terminal devices 10. It is set up to receive, process and forward messages of the background systems 30 to a corresponding network operator 40 as well as messages from a network operator 40 to a corresponding background system 30. The service platform 50 is expediently operated by a provider that is independent of the network operators 40 and the operators of the background systems 30.

Background systems 30, service platform 50 and network operator 40 are implemented in the form of data processing devices on which programs are executed that implement the described functions. Likewise, the terminal device 10 has a data processing unit on which the described functions are executed by executing corresponding programs.

The proposed solution is not limited to vehicles or cars. It is suitable for all terminal devices 10 which are connected on the one hand to a background system 30 and on the other hand are set up to be connected to a network operator 40 according to user choice.

The following description is based on the exemplary embodiment that the terminal devices 10 are cars of different manufacturers and the network operators 40 are mobile communication operators. The background systems 30 are assumed to be configured as management systems of car manufacturers.

The terminal device 10, i.e., for example, a car, has a management interface 12 to an associated management system 30. The management interface 12 is usually permanently configured. It is based on a data link 20, which is conveniently established via a mobile communication network 46. For example, it is realized via a subscriber identity module using a first secure element 16 implemented in the car in the form of an eUICC or iUICC. Stored on the secure element 16 are authentication data for a network operator 40, specified e.g. by a car manufacturer or a vehicle operator, by means of which data the terminal device 10 is connected to the data exchange network 46 of the network operator 40 and thereby to the management system 30.

In variants, the data link can also be established via another wireless network technology, e.g. WiFi or satellite communication.

The terminal device 10, i.e., for example the car, also has a user interface 14 for both receiving and outputting data to and from a user. The user interface 14 may comprise means for manually individually entering data by a user, such as touch-sensitive displays, keyboards, sensors or cameras. It can also comprise means for entering data in a device-based manner, such as reader devices for reading out memory elements, or an interface for exchanging data with a cellphone.

The terminal device 10 additionally has a second secure element 18, which allows access to a mobile communication network 46 via a second data link 22 to a network operator 40. The second secure element 18 can, for example, also be in the form of an eSIM on an eUICC or iUICC, or by a functionality that makes it possible to manage multiple parallel accesses to a mobile communication network on a secure element, e.g. by setting up MEP-Multiple Enabled Profiles. Both secure elements 16, 18 can in principle be active simultaneously and can be operated according to the DSDA (Dual SIM Dual Active) principle or the DSDS (Dual SIM Dual Standby) principle. By means of the secure element 18, a terminal device 10 can establish a connection to a mobile communication network 46 in a manner known per se.

In a variant, only a single secure element may also be provided, which provides a first basic connection (bootstrap connectivity) when usage starts, which after the initial loading of a profile and setting up a user-related end customer connection is replaced by this connection. This first basic connection can also be established via another wireless network technology, e.g. WiFi or satellite communication.

The service platform 50 has a defined interface to each connected management system 30. It also has a defined network operator interface to each of the connected network operators 40. It also has a control unit and a storage device 52.

The storage device 52 stores data for each user for whom a terminal device 10 has been set up via the service platform 50, which defines a federation identity within the management system. The structure of this data is illustrated in FIG. 2, which shows part of a storage device 52 of a service platform 50. The data generally comprises an individual group identifier VK, the terminal device identifiers EK of one or more terminal devices 10, i.e., for example, cars, and respectively assigned control data KD for setting up a service configuration in a terminal device 10. The data further includes authorization tokens BT that are issued by network operators 40. The data also includes status information about completed activations of telecommunications profiles. The data is conveniently stored in federation accounts 54 maintained on the service platform 50, wherein each federation account 54 is identified by a unique group identifier VK and is thereby assigned to a user.

The network operators 40 operate data exchange networks 46, and provide therein communication services for terminal devices 10 in a known manner. The following assumes that the network operators 40 are mobile communication operators and the data exchange networks 46 are mobile communication networks.

Each mobile communication operator 40 has a profile data output unit 42, typically in the form of an SM-DP+, via which in particular telecommunications profiles are output to terminal devices 10, and a server 44 for storing customer-specific profile and subscriber data.

The connection between terminal device 10 and mobile communication operator 40 in a mobile communication network 46 is made via a communication service provided by the mobile communication provider 46. Usually, this provider uses standardized methods, as described e.g. in the GSMA standard SGP.22.

Prerequisites for using the communication services are authentication and proof of access authorization. The proof of access authorization is provided by means of a secure element 18 stored on the terminal device 10, typically in the form of an eSIM. Authorization data is stored on the secure element 18, typically in the form of telecommunications profiles TP. The telecommunications profiles TP, also referred to for short as profiles in the following, contain information that is necessary to be able to make telephone calls and interact in a mobile communication network 46. Profiles TP belong to and are provided by the respective mobile communication provider 40. They typically include at least one network access authorization, typically an IMSI, profile management keys, and authentication parameters.

The arrangement shown in FIG. 1 allows a user to establish network access on a first terminal device 10 and to provide network access available to a user on a first terminal device 10 also on a further terminal device 10 with the same functionality.

In a login routine, the user sets up a group identifier VK on a service platform 50. FIG. 3 shows the first-time setup of a group identifier VK on a service platform 50 by a user for whom no group identifier VK has yet been stored on the service platform 50.

In a first step 100, the user authenticates him/herself on the terminal device 10. The authentication conveniently takes place electronically using an authentication device 60. This can be a portable device in the form of an electronic key, an IC card or a cellphone, for example. Or, the authentication device 60 can be permanently connected to the terminal device 10, for example in the form of an input unit, a biometric sensor or a camera.

Then, in a step 102, the user authenticates him/herself against the background system 30 which is assigned to the terminal device 10. The second authentication can be carried out in the same way as the first authentication. It may require the presentation of additional proof of authentication, such as in the form of a secret number. The two authentication steps 100, 102 can also be combined, so that authentication takes place against the terminal device 10 and the background system 30 simultaneously.

After authentication, the background system 30 determines whether the user wants to set up a group identifier VK. If this is the case, the background system 30 sends a request to the service platform 50 in the following step 104.

The service platform 50 then transmits to the background system 30, step 106, a list of selectable network operators 40, which is forwarded to the user from the background system 30 via the terminal device 10.

The user selects a network operator 40 with an associated data exchange network 46, step 108, and communicates this via the terminal device 10 to the background system 30, which forwards the notification to the service platform 50.

In the next step 110, the service platform 50 transmits a request for the provision of an authorization token BT to the selected network operator 40.

The network operator 40 receives the request and then starts an authentication routine 112, in which the user proves their authorization to use the selected network 46. The network operator 40 sends a message to the user, either directly or via the service platform 50, the background system 30 and the terminal device 10, requesting presentation of the authorization data. The user then presents their authorization data. The authorization data may, for example, be authentication data for logging a user's mobile communication device, such as a smart phone, into a mobile communication network.

The network operator 40 checks the authorization data. If the check is positive, in the following step 114 the operator calculates an authorization token BT, which entitles an authority subsequently submitting the authorization token BT to request a telecommunications profile TP belonging to the authorization token BT. The authorization token BT is a data record and must be created in such a way that it is unique for a background system 30 and a specific network operator 40. This means that there must be no ambiguity with respect to the network operator 40.

The network operator 40 transmits the authorization token BT to the service platform 50, step 116.

Subsequently, the network operator 40 updates the user's profile stored in the server 44, step 118.

The service platform 50 then creates a federation account 54 for the user on the service platform 50, unless this has already been done on receipt of the request. For this purpose, in step 120, the service platform 50 forms a group identifier VK, which is specific to the federation account 54. Furthermore, the service platform 50 generates access data ZD in order to be able to access the federation account 54 and the calculated group identifier VK associated with it. The access data ZD is or contains a secret, typically a password or a PIN. The group identifier VK links the service platform 50 to the federation account 54 and thereby to the authorization token BT. It stores the link and authorization token BT in the federation account 54, step 122.

In the following step 124, the service platform 50 transmits the group identifier VK to the background system 30. This updates, step 126, the user account 32 maintained there.

In a further subsequent step 128, the service platform 50 transmits the group identifier VK and the access data ZD for the group identifier VK to the user via the background system 30 and the terminal device 10.

Thereafter, the service platform 50 is set up for the user. A federation account 54 has been set up, which the user can access by submitting the access data ZD.

FIG. 4 shows the user-related setup of a terminal device 10 via an assigned background system 30 if a group identifier VK for the user is already stored in the background system 30.

In a first step 200, the user authenticates him/herself on the terminal device 10. The authentication conveniently takes place electronically using an authentication device 60. This can be a portable device in the form of an electronic key, an IC card or a cellphone, for example. Or, the authentication device 60 can be permanently connected to the terminal device 10, for example in the form of an input unit, a biometric sensor or a camera.

Then, step 202, the user authenticates him/herself against the background system 30 which is assigned to the terminal device 10. The second authentication can be carried out in the same way as the first authentication. It may require the presentation of additional proof of authentication, such as in the form of a secret number. The two authentication steps 200, 202 can also be combined, so that authentication takes place against the terminal device 10 and the background system 30 simultaneously. As part of the authentication, the terminal device identifier EK is transmitted to the background system 30.

After successful authentication, the background system 30, step 204, checks whether a group identifier VK for the terminal device 10 is stored in the background system 30 and a federation account 54 has been set up on the service platform 50.

If this is the case, the background system 30, step 206, sends a request for a profile to the service platform 50. The profile request contains a data item that uniquely identifies the federation account 54, the group identifier VK or the user. In particular, the data item can be the group identifier VK itself. In a variant, an authorization token BT for the user can already be stored in the background system 30. If this is the case, the request can also be made by the background system 30 sending the authorization token BT to the service platform 50.

The service platform 50 determines the federation account 54 for the user on the basis of the request and identifies the authorization token BT stored there and the associated network operator 40, step 208. The authorization token is transmitted by the service platform 50 to the identified network operator 40, step 209.

The network operator 40 checks the received authorization token BT. If this is approved, it provides the user with a telecommunications profile TP, step 210; it also calculates download information DI for the profile TP. The network operator 40 stores the determined telecommunications profile TP in a server 44 of the network operator, and it transmits the download information DI to the service platform 50, step 212. If the terminal device 10 has been set up in accordance with the SGP.22 standard, the download information DI is typically an activation code in accordance with the SGP.22 standard.

After receiving the download information DI, the service platform 50 updates the federation account 54 that it maintains, step 214. Furthermore, the service platform 50 identifies control data KD that may be stored in the federation account 54 for setting up a service configuration, i.e. for setting up customer-specific settings and services in a terminal device 10.

The control data KD can be used, for example, if the terminal device is a vehicle 10, to set up customer-specific, terminal-independent value-added services on an infotainment system of the vehicle, e.g. to be able to use audio data or carry out payment transactions. In other terminal devices 10 they can be used, for example, to set up a 5G router, a 5G modem of a portable computer or a 5G modem in a mobile device. The control data KD and/or the configuration of the services are conveniently defined by the user during the normal operation of a terminal device 10 and transmitted from the terminal device 10 to the respective background system 30. The background system 30 involved transmits new or modified control data KD to the service platform 50.

In the following step 216, the service platform 50 transmits the download information DI together with the control data KD to the background system 30 to set up a service configuration.

The background system 30 updates the user account that it maintains, step 218. Furthermore, the background system 30 transmits the download information DI and the control data KD for setting up a service configuration to the terminal device 10, step 220.

After receiving the download information DI via the data link 22, the terminal device 10 establishes a direct connection to the network operator 40 associated with the download information DI and in a step 222 requests the network operator to transmit a telecommunications profile TP using the download information DI.

The network operator 40 checks the request and, if it is approved, sends the profile TP provided for this purpose via the data link 22 to the terminal device 10, step 224.

The terminal device 10 sets up the telecommunications profile TP and activates it, step 226. The request for the profile TP and the activation in the terminal device 10 are carried out, for example, in accordance with the GSMA standards, e.g. according to the GSMA standard SGP.22.

In addition to setting up the telecommunications profile TP, the terminal device 10 configures the services provided by the terminal device 10 based on the received control data KD. Once the services have been activated and set up, the terminal device 10 sends confirmation information to the background system 30, step 228.

The background system 30 then updates the user account 32, step 230, and in turn sends configuration information to the service platform 50, step 232.

The service platform 50 then updates the federation account 54 that it maintains, step 234. It stores the activation of the transferred telecommunications profile TP as the new state of the terminal device 10.

In an independently executed step 240, the network operator 40 furthermore updates the customer-specific data stored in the server 44 after transmission of the telecommunications profile TP and also stores the activation of the transmitted telecommunications profile TP.

FIG. 5 shows the user-related setup of a second terminal device 10 via an assigned background system 30 if no group identifier VK for the user has yet been stored in the background system 30, but a federation account 54 has already been set up for the user on the service platform 50.

In a first step 300, the user first authenticates him/herself on the second terminal device 10. The authentication conveniently takes place electronically using an authentication device 60. This can be a portable device in the form of an electronic key, an IC card or a cellphone, for example. Or, the authentication device 60 can be permanently connected to the terminal device, for example in the form of an input unit, a biometric sensor or a camera.

Then the second terminal device 10 logs the user into the background system 30 which is assigned to the second terminal device 10, step 302. As part of the login process, the second terminal device 10 transmits its terminal device identifier EK to the background system 30. Furthermore, the terminal device 10 determines the group identifier VK of the user. This can take place either by issuing a corresponding input prompt via the interface 14 or, if the user is using an authentication device 60, for example in the form of an electronic key, an IC card or a cellphone, automatically.

After receiving the group identifier VK, the background system 30 determines whether a link to the group identifier VK is already stored in the user account 32, step 304.

If this is not the case, as in the exemplary embodiment of FIG. 5, the background system 30 sends the group identifier VK to the service platform 50. Together with the group identifier VK, it transmits the identifier EK for the terminal device 10, step 306.

After receiving the group identifier VK, the service platform 50 checks whether a federation account 54 has already been created for this, step 308. If this is the case, as assumed in the exemplary embodiment, the service platform 50 requests the user to authenticate him/herself.

For this purpose, the service platform 50 conveniently sends a message via the background system 30 to the second terminal device 10, in which the user is prompted to log into the federation account 54, step 310. If, as assumed in the example, simple authentication is provided for the login, the user presents a secret to authenticate him/herself against the service platform 50. The secret is, for example, the password belonging to the federation account 54 or a PIN. It is transmitted via the second terminal device 10 and background system 30 to the service platform 50, step 312.

As an alternative to simple authentication, extended security mechanisms, for example two-factor authentication, may also be used. The process is then accordingly adapted.

The service platform 50 checks the login data received. If it is correct, the service platform 50 determines the authorization token BT from the federation account 54 designated by the group identifier VK and links the token to the second terminal device 10, step 314. For this purpose, the service platform 50 links the federation account 54 and thus the authorization token BT to the identifier EK of the second terminal device 10.

Then the service platform 50 updates the federation account 54, step 316, and adds the previously created link to the second terminal device 10. This can be done by storing the terminal device identifier EK of the second terminal device 10 in the federation account 54 as known. In the federation account 54 there is now at least one link to the second terminal device 10 carrying out the current setup and a link to a terminal device 10 for which a link was stored at an earlier point in time.

In a next step, the service platform 50 sends the authorization token BT to the identified network operator 40, step 318. In addition, the service platform 50 sends information about the updated group identifier VK to the background system 30, step 320. The background system 30 updates the user account 32 upon receipt, step 322.

The following steps correspond to the steps described with reference to FIG. 4 for the user-related setup of a terminal device 10 via an assigned background system 30 if a group identifier VK for the user is already stored in the background system 30.

The network operator 40 checks the received authorization token BT. If this is approved, it provides the user with a telecommunications profile TP, step 324; said profile TP is equivalent to the profile for the terminal device 10 for which a link was stored in the federation account 54 at an earlier point in time; both profiles typically form the basis for the same customer contract.

Said network operator also calculates download information DI for the profile TP. The network operator 40 stores the identified telecommunications profile TP in a server of the network operator 40. It transmits the download information DI to the service platform 50, step 326. If the terminal device 10 has been set up in accordance with the SGP.22 standard, the download information DI is typically an activation code in accordance with SGP.22.

After receiving the download information DI, the service platform 50 updates the federation account 54 that it maintains, step 328. Furthermore, the service platform 50 identifies control data KD stored in the federation account 54 for setting up a service configuration on the terminal device 10.

In the following step 330, the service platform 50 transmits the download information DI together with the control data KD for setting up a service configuration to the background system 30.

The background system 30 updates the user account that it maintains, step 332. Furthermore, the background system 30 transmits the download information DI and the control data KD for setting up a service configuration to the terminal device 10, step 334.

After receiving the download information DI, the terminal device 10 establishes a direct connection via the data link 22 to the network operator 40 associated with the download information and in step 336 requests the network operator to transmit a telecommunications profile TP using the download information DI.

The network operator 40 checks the request, identifies the profile TP provided for this purpose and sends it via the data link 22 to the second terminal device 10, step 338.

The second terminal device 10 sets up the telecommunications profile TP and activates it, step 342. The requesting of the telecommunications profile TP and the activation in the terminal device 10 are expediently carried out in accordance with a GSMA standard, for example GSMA standard SGP.22.

In addition to setting up the telecommunications profile TP, the second terminal device 10 configures the services provided by the second terminal device 10 based on the received control data KD, step 344. Once the services have been activated and set up, the second terminal device 10 sends confirmation information to the background system 30, step 346.

The background system 30 then updates the user account 32, step 348, and in turn sends configuration information to the service platform 50, step 350.

After receipt the service platform 50 then updates the federation account 54 that it maintains, step 352. The platform stores the activation of the transferred telecommunications profile TP as the new state of the second terminal device 10.

In an independently executed step 340, the network operator 40 furthermore updates the customer-specific profile data stored in the server 44 after transmission of the telecommunications profile TP and also stores the activation of the transferred telecommunications profile TP.

The second terminal device 10 is then set up to establish a connection to the data exchange network 46 designated by the telecommunications profile TP using the same telecommunications profile TP that was initially provided for another terminal device 10. In addition, services that a user had defined at an earlier point in time are configured on the terminal device 10. The user account 32 belonging to the terminal device 10 also stores the user's group identifier VK. The user can then use it to also rapidly set up further terminal devices 10 to which the same background system 30 is assigned.

While maintaining the underlying idea, the prescribed solution allows for a variety of embodiments and variants that are not individually described. This applies to the design and structure of the data-processing components, among others. The structures adopted in the description and the elements of the exemplary embodiments described by way of the figures should furthermore not be understood respectively as only exhaustively forming possible embodiments in the arrangement exactly as described. Where expedient and possible, combinations and modifications of the elements and processes are in fact possible.

### LIST OF REFERENCE SIGNS

10 user terminal device
12 interface
14 user interface
16 secure element
18 secure element
20 data link
22 data link
24 data link
26 data link
30 background system
32 user account
40 network operator
42 profile data output unit
44 server
46 data exchange network
50 services platform
52 storage device
54 federation account
60 authentication device
VK group identifier
EK terminal device identifier
BT authorization token
DI download information
TP telecommunications profile
KD control data for setting up a service configuration
ZD access data

1.-15. (canceled)

16. A method for the user-related setup of a terminal device which is connected to a background system,
wherein the terminal device is connected to a data exchange network by means of a telecommunications profile stored in a secure element,
wherein a service platform is provided, which is connected to the background system and to at least one network operator operating a data exchange network,
wherein an authorization token for providing a telecommunications profile belonging to the authorization token is stored in the service platform,
wherein the authorization token is linked to a group identifier,
wherein a group identifier or a profile request designating a group identifier is transmitted to the service platform from a background system,
wherein the service platform identifies an authorization token linked to the group identifier after receiving a group identifier or a profile request designating a group identifier,
wherein by means of the identified authorization token, the service platform effects, via a network operator, the loading of a telecommunications profile belonging to the authorization token into the secure element contained in the terminal device,
wherein the terminal device is set up to be connected to the data interchange network.

17. The method according to claim 16, wherein the service platform is configured to request a secret from a user after receiving a group identifier or a profile request designating a group identifier, in order to authenticate the user on the service platform.

18. The method according to claim 16, wherein the service platform is configured to link an authorization token for a group identifier stored on the service platform to a further terminal device.

19. The method according to claim 16, wherein the service platform is configured to establish a connection to a network operator and to cause said operator to generate a telecommunications profile and to send back associated download information.

20. The method according to claim 19, wherein the service platform transfers the download information to the background system.

21. The method according to claim 16, wherein the service platform generates access data for a group identifier, which data either is or contains a secret, and the access data is transmitted to the user.

22. The method according to claim 16, wherein control data for a group identifier for setting up a service configuration is also stored in the service platform, said data being transmitted to the background system,
wherein the stored services are set up on the terminal device by means of the control data.

23. The method according to claim 22, wherein the service configuration is the setting up of an infotainment system in a vehicle, or the setting up of customer-specific settings and services in a device equipped with a mobile communication unit such as a computer or a 5G router.

24. The method according to claim 16, wherein a user is authenticated on the terminal device.

25. The method according to claim 24, wherein the authentication of the user on the terminal device is carried out by means of an authentication device.

26. The method according to claim 16, wherein the group identifier is transmitted by means of an authentication device.

27. The method according to claim 16, wherein the group identifier and the secret for authentication by the service platform are generated in a login routine, in which a user determines a data exchange network for which a telecommunications profile is to be provided.

28. The method according to claim 16, wherein the service platform is set up to request an authorization token from a data exchange network determined by a user and, upon receipt, to calculate a group identifier and to link this to the authorization token.

29. The method according to claim 16, wherein the terminal device is a vehicle or a device with a mobile communication unit.

30. A service platform for a management system for the user-related setup of a terminal device,
wherein the service platform is connected to at least one network operator and to at least one background system,
wherein at least one background system is connected to the terminal device and the terminal device is connected by means of a telecommunications profile, stored in a secure element, to a data exchange network,
wherein the service platform is set up to execute the following steps:
receiving, processing and forwarding messages from the at least one background system to a network operator,
receiving, processing and forwarding messages from at least one network operator to a background system,
setting up a federation account that is linked to a group identifier,
storing an authorization token for providing a telecommunications profile in the federation account,
receiving a group identifier and a terminal device identifier via a background system,
checking whether a federation account with an authorization token has already been created for the received group identifier,
requesting a secret from a user if a federation account has already been created,
linking the terminal device identifier to the federation account in the event of successful transmission of the secret,
effecting the provision of a telecommunications profile for the terminal device designated by the terminal device identifier via a network operator using the authorization token stored in the federation account.
